(19) United States
(12) Patent Application Publication
(10) Pub. No.: US 2009/0066953 A1
(43) Pub. Date: Mar. 12, 2009

(54) SPECTROSCOPIC ELLIPSOMETER AND FILM THICKNESS MEASURING APPARATUS

(75) Inventor: Masahiro HORIE, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 12/204,983

(22) Filed: Sep. 5, 2008

(30) Foreign Application Priority Data
Sep. 12, 2007 (JP) P2007-236277

(51) Int. Cl. G01J 4/00; G01B 11/28

(52) U.S. Cl. 356/369; 356/364; 356/630

(57) ABSTRACT

In a spectroscopic ellipsometer, reflected light reflected on a measurement surface of a substrate is divided into a first polarized light being a linearly polarized component and a second polarized light being a linearly polarized component in a polarization direction perpendicular to the first polarized light, by an analyzer. A polarization state at each wavelength of the reflected light is measured with the first polarized light, and the size and shape of the irradiation region on the measurement surface are detected with the second polarized light. In the spectroscopic ellipsometer, detection of the size and shape of the irradiation region is performed with the second polarized light not used in measurement of the polarization state, out of the reflected light. Therefore, it is possible to detect the size and shape of the irradiation region with high accuracy with highly maintaining the measurement accuracy of the polarization state.

### BACKGROUND OF THE INVENTION

1. Field of the Invention

The present invention relates to a spectroscopic ellipsometer and a film thickness measuring apparatus having the spectroscopic ellipsometer.

2. Description of the Background Art

Conventionally, an ellipsometer is used as an optical measuring apparatus for measuring a thickness of a film formed on an object or the like. In the ellipsometer, polarized light is applied to a measurement surface of the object so as to incline to the measurement surface, a polarization state of reflected light reflected on the measurement surface is acquired and ellipsometry is performed to measure a film thickness or the like on a substrate. For example, U.S. Pat. No. 5,608,526 (Document 1) and Japanese Patent Application Laid-Open No. 2005-3666 (Document 2) disclose a spectroscopic ellipsometer for performing film thickness measurement and the like on a thin film formed on an object on the basis of a polarization state at each wavelength of the reflected light.

In such a spectroscopic ellipsometer, in order to achieve high-precision measurement, it is necessary that an irradiation region of polarized light on a measurement surface of the object is a desired size and shape. Especially, in a case where ellipsometry of a semiconductor substrate where a fine pattern is formed or the like is performed, the size and the shape of a small irradiation region must be adjusted with high accuracy.

However, in a case that the measurement surface of the object is moved in the vertical direction from a convergence position where the polarized light applied to the object is most converged (i.e., in a case that the measurement surface is in a defocused state), the irradiation region becomes larger than the desired size. In measurement of a substrate where a transparent film or the like is formed on a measurement surface, there is a case where the polarized light is reflected on both of an upper surface of the film and a boundary between the film and a substrate main body (i.e., the polarized light is multiply reflected) and the irradiation region spreads.

In a case where a measurement surface of an object is rough (not smooth), the polarized light is nonuniformly applied onto the measurement surface, the irradiation region becomes ambiguous and spreads. In measurement of an object where projections and depressions such as a pattern are formed on a measurement surface, there is a possibility that an edge of the pattern is included in the irradiation region by an error in positional adjustment of the object or the like, and the width of the irradiation region is different in a right region and a left region of the edge of the pattern. As described, in the case that the irradiation region has a different size or shape from the desired one, if measurement is performed without recognition of abnormality in size or shape of the irradiation region, it results in acquisition of an error in measurement result.

When measures for detecting the size and shape of the irradiation region on the measurement surface of the object are considered, in order to observe the irradiation region at an observation optical system of vertical incident light type like in Document 1, scattered light needs to be observed by positioning a scattering plate or the like at a position on the object where the polarized light is applied and it is difficult to accurately detect an actual size and shape of the irradiation region on the measurement surface.

### SUMMARY OF THE INVENTION

The present invention is intended for a spectroscopic ellipsometer. It is a main object of the present invention to detect the size and the shape of an irradiation region on an object with high accuracy.

The spectroscopic ellipsometer according to the present invention comprises: a light irradiation part for directing polarized light to an object, the polarized light being inclined to the object; an analyzer for dividing light reflected on the object into a first polarized light which is a linearly polarized component in a predetermined polarization direction and a second polarized light which is a linearly polarized component in a polarization direction perpendicular to the first polarized light; a rotating phase retarder which is positioned between the light irradiation part and the object or between the object and the analyzer and rotates around a central axis parallel to an optical axis; a spectrometer for receiving the first polarized light; and an imaging part for receiving the second polarized light to pick up an image of an irradiation region of the polarized light on the object. In the spectroscopic ellipsometer, it is possible to detect the size and the shape of the irradiation region with high accuracy with using the second polarized light out of the reflected light reflected on the object, the second polarized light being a polarized component which is not used in measurement of a polarization state.

According to a preferred embodiment of the present invention, the spectroscopic ellipsometer further comprises an aperture plate which is positioned on an optical axis between the analyzer and the spectrometer and has a slit aperture extending in a direction which is substantially parallel to a measurement surface on the object and perpendicular to the optical axis, and when 2θ is an angle viewing a width of the slit aperture from an intersection of the measurement surface and the optical axis, sin θ is equal to or smaller than 0.05. With this structure, since the polarization state is measured with use of only the light which enters the measurement surface at an almost desired incident angle, it is possible to improve the measurement accuracy of the polarization state.

According to another preferred embodiment of the present invention, light including ultraviolet light is emitted from the light irradiation part, and an ultraviolet light transmitting filter for transmitting ultraviolet light with blocking visible light is provided on an optical axis between the analyzer and the imaging part. It is thereby possible to suppress influences by light other than from the lighting part and to improve the detection accuracy of the size and shape of the irradiation region.

According to still another preferred embodiment of the present invention, the irradiation region is an approximately rectangle.

According to still another preferred embodiment of the present invention, the spectroscopic ellipsometer further comprises: a holding part for holding an object; an elevating mechanism for moving the object in a vertical direction perpendicular to the measurement surface of the object, together with the holding part; and a focusing part which controls the elevating mechanism and the imaging part and repeats movement of the object in the vertical direction and image pickup of the irradiation region, to make an area of the irradiation region minimum. With this structure, focusing is automatically performed.

The present invention is also intended for a film thickness measuring apparatus for measuring a thickness of a film formed on an object.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a construction of a film thickness measuring apparatus;

FIG. 2 is a plan view showing an irradiation region on a measurement surface of a substrate;

FIGS. 3A to 3D are plan views each showing an example of an irradiation region having a different size and shape from a desired shape; and

FIG. 4 is a flowchart showing a flow of focusing.

### DESCRIPTION OF THE PREFERRED EMBODIMENTS

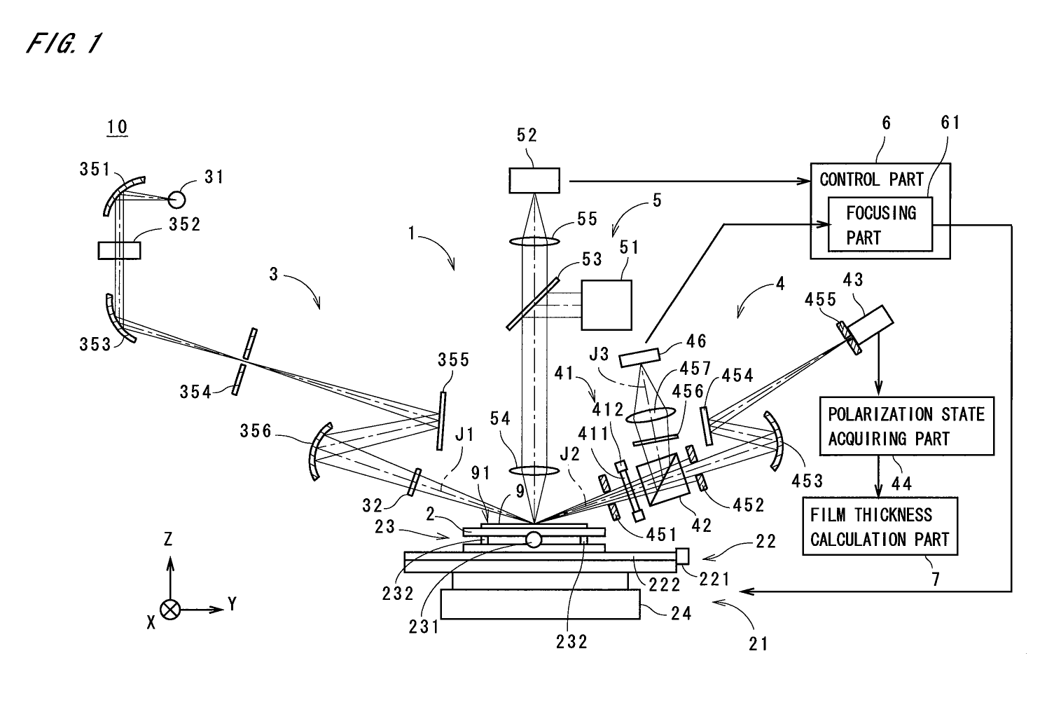

FIG. 1 is a view showing a construction of a film thickness measuring apparatus 10 in accordance with a preferred embodiment of the present invention. The film thickness measuring apparatus 10 is an apparatus for measuring a thickness of a thin film formed on a semiconductor substrate 9 which is a measurement object. In the following discussion, the semiconductor substrate 9 is simply referred to as a “substrate 9”. In FIG. 1, a part of the structure of the film thickness measuring apparatus 10 is shown cross-sectionally.

As shown in FIG. 1, the film thickness measuring apparatus 10 has a spectroscopic ellipsometer 1 for applying polarized light to a main surface 91 on the substrate 9, a thin film being formed on the main surface 91 (i.e., the main surface 91 is a main surface to be measured on the (+Z) side in FIG. 1 and hereinafter, referred to as a “measurement surface 91”), to acquire information which is used to perform ellipsometry on the measurement surface 91 and a film thickness calculation part 7 for performing ellipsometry on the basis of the information acquired by the spectroscopic ellipsometer 1 to obtain a thickness of the film formed on the measurement surface 91.

The spectroscopic ellipsometer 1 has a stage 2 which is a holding part for holding the substrate 9 having the measurement surface 91, a stage moving mechanism 21 for moving the stage 2 in parallel with the measurement surface 91 of the substrate 9, a stage elevating mechanism 24 for moving the stage 2 in a vertical direction (the Z direction in FIG. 1) perpendicular to the measurement surface 91 of the substrate 9, a lighting part 3 which is a light irradiation part for directing polarized light to the measurement surface 91 of the substrate 9, the polarized light being inclined to the measurement surface 91, a light receiving part 4 for receiving reflected light of the polarized light which is emitted from the lighting part 3, a substrate observing part 5 which is used for position adjustment of the substrate 9 in directions along the measurement surface 91 (i.e., the directions are the X direction and the Y direction in FIG. 1), and a control part 6 which is constituted of a CPU for performing various computations, a memory for storing various pieces of information and the like and controls the other constituent elements of the spectroscopic ellipsometer 1.

The stage moving mechanism 21 has a Y-direction moving mechanism 22 for moving the stage 2 in the Y direction of FIG. 1 and an X-direction moving mechanism 23 for moving the stage 2 in the X direction. The Y-direction moving mechanism 22 has a motor 221 and a ball screw (not shown) connected with the motor 221, and with rotation of the motor 221, the X-direction moving mechanism 23 moves in the Y direction of FIG. 1 along guide rails 222. The X-direction moving mechanism 23 has the same constitution as the Y-direction moving mechanism 22, and with rotation of a motor 231, the stage 2 is moved by a ball screw (not shown) in the X direction along guide rails 232.

The lighting part 3 has a light source 31 which is a high-intensity xenon (Xe) lamp for emitting white light including ultraviolet light, various optical elements (i.e., an ellipsoidal mirror 351, an infrared cut filter 352, an ellipsoidal mirror 353, a lighting part aperture plate 354, a plane mirror 355 and an ellipsoidal mirror 356) for directing light from the light source 31, and a sheet-like (or a thin-plate) polarizer 32. The light emitted from the light source 31 is polarized by the polarizer 32 and the polarized light enters the measurement surface 91 of the substrate 9 from the lighting part 3, the polarized light being inclined to the measurement surface 91 (at an incident angle of 70 degrees in the present preferred embodiment). The ellipsoidal mirror described here means an aspherical mirror whose reflective surface is a part of a rotationally symmetric ellipsoidal surface (spheroidal surface).

The light receiving part 4 has a rotating phase retarder (a rotating phase shifter) 41 where the reflected light of the polarized light from the lighting part 3 enters through a first aperture plate 451, an analyzer 42 which receives light after passing through the rotating phase retarder 41 and divides the light into two lights, a spectrometer 43 for receiving one light from the analyzer 42 to acquire spectral intensity (i.e., light intensity at each wavelength), a polarization state acquiring part 44 connected to the spectrometer 43, an imaging part 46 for receiving the other light from the analyzer 42 to pick up an image of an irradiation region of the polarized light on the substrate 9, and various optical elements for directing the reflected light reflected on the substrate 9 to the spectrometer 43 and the imaging part 46.

The rotating phase retarder 41 positioned between the substrate 9 and the analyzer 42 has a wave retardation plate (λ/4 plate) 411 which is formed of magnesium fluoride (MgF₂). The wave retardation plate 411 is rotated around an axis parallel to an optical axis J2 between the substrate 9 and the analyzer 42 in the light receiving part 4, by a stepping motor 412 which is controlled by the control part 6. Thus, polarized light in accordance with a rotation angle of the stepping motor 412 is led out from the wave retardation plate 411 to enter the analyzer 42.

A Glan-Thompson prism is used as the analyzer 42 in the present preferred embodiment. The light entering the analyzer 42 is divided into a first polarized light which is a linearly polarized component in a predetermined polarization direction and a second polarized light which is a linearly polarized component in a polarization direction perpendicular to the first polarized light, and the first polarized light and the second polarized light are emitted toward directions almost perpendicular to each other. The first polarized light enters the spectrometer 43 through a second aperture plate 452, an ellipsoidal mirror 453, a plane mirror 454, and a third aperture plate 455, and the second polarized light enters the imaging part 46 through an ultraviolet light transmitting filter 456 for transmitting ultraviolet light with blocking visible light and a lens 457. In the preferred embodiment, the imaging part 46 has a plurality of light receiving elements of CCD (charge coupled device) type.

The substrate observing part 5 has an observation light source 51 for emitting white light and a camera 52 for position adjustment of the substrate 9. Light emitted from the observation light source 51 enters the measurement surface 91 of the substrate 9 through a half mirror 53 and an objective lens 54 so as to be perpendicular to the measurement surface 91, and reflected light reflected on the substrate 9 is received by the camera 52 through the half mirror 53 and a lens 55. In the spectroscopic ellipsometer 1, the camera 52 picks up an image of a mark for position adjustment (so-called alignment mark) provided on the measurement surface 91 of the substrate 9. The control part 6 controls the X-direction moving mechanism 23 and the Y-direction moving mechanism 22 in the stage moving mechanism 21 on the basis of the image of the mark and performs position adjustment of the substrate 9 in the X direction and the Y direction.

Next, discussion will be made on details of the lighting part 3 and the light receiving part 4. In the lighting part 3, the light emitted from the light source 31 is directed to an aperture of a lighting part aperture plate 354 through the ellipsoidal mirror 351, the infrared cut filter 352, and the ellipsoidal mirror 353. In the lighting part aperture plate 354, the shape of the aperture in a direction perpendicular to an optical axis J1 in the lighting part 3 has a rectangular shape with long sides of 150 μm parallel to the X axis and short sides of 50 μm orthogonal thereto. Light after passing through the aperture is directed to the plane mirror 355, gradually expanding so that sine of an angle θ₁ formed between the light and the optical axis J1 (i.e., the angle θ₁ is a half of a divergence angle) is 0.02.

The light from the lighting part aperture plate 354 is reflected on the plane mirror 355 and further directed to the ellipsoidal mirror 356, and light reflected on the ellipsoidal mirror 356 is directed to the polarizer 32 while being collected at a numerical aperture (NA) of 0.1. Then, polarized light which is led out by the polarizer 32 is applied to the irradiation region on the measurement surface 91 of the substrate 9 at an incident angle of 70 degrees. In the film thickness measuring apparatus 10, the measurement surface 91 is located at a convergence position where the polarized light which is emitted from the lighting part 3 to the substrate 9 is most converged, and the optical system from the lighting part aperture plate 354 to the substrate 9 is a minification optical system at a ratio of 5:1. Therefore, the luminous flux section perpendicular to the optical axis J1 of the polarized light near the measurement surface 91 of the substrate 9 has a rectangular shape with long sides of 30 μm parallel to the X axis and short sides of 10 μm orthogonal thereto, and the irradiation region of the polarized light on the substrate 9 is an approximately rectangular region (i.e., an approximately square region) with each side of about 30 μm.

The reflected light reflected on the substrate 9 is drawn into the first aperture plate 451 which is positioned between the substrate 9 and the analyzer 42 and led out to the rotating phase retarder 41. A slit aperture of the first aperture plate 451 extends in parallel with the X axis (i.e., the slit aperture extends in a direction which is substantially parallel to the measurement surface 91 of the substrate 9 and perpendicular to the optical axis J2 between the substrate 9 and the analyzer 42 in the light receiving part 4). With respect to a direction perpendicular to the X axis (a direction which almost corresponds to height), when 2θ₂ is an angle viewing the slit aperture of the first aperture plate 451 from an intersection of the measurement surface 91 of the substrate 9 and the optical axis J2 (i.e., the angle formed between a direction viewing an upper edge of the first aperture plate 451 and a direction viewing a lower edge of the first aperture plate 451), sin θ₂ is 0.1.

In the rotating phase retarder 41, the wave retardation plate 411 rotates around the axis parallel to the optical axis J2 by the stepping motor 412 and thereby, polarized light in accordance with a rotation angle of the stepping motor 412 (i.e., in accordance with a rotation position of the wave retardation plate 41) is led out from the wave retardation plate 41 and directed to the analyzer 42.

The polarized light incident on the analyzer 42 is divided into the first polarized light and the second polarized light. The first polarized light travels in a straight line located on an extension of the path of the light which is directed from the substrate 9 to the analyzer 42, to be drawn into the second aperture plate 452 which is positioned on the optical axis J2 between the analyzer 42 and the spectrometer 43. A slit aperture of the second aperture plate 452 extends in parallel with the X axis (i.e., the slit aperture extends in a direction which is substantially parallel to the measurement surface 91 of the substrate 9 and perpendicular to the optical axis J2 in the light receiving part 4). With respect to the direction perpendicular to the X axis (the direction which almost corresponds to height), when 2θ₃ is an angle viewing the slit aperture of the second aperture plate 452 from the intersection of the measurement surface 91 of the substrate 9 and the optical axis J2 (i.e., the angle formed between a direction viewing an upper edge of the second aperture plate 452 and a direction viewing a lower edge of the second aperture plate 452), sin θ₃ is equal to or smaller than 0.05 (0.05 in the present preferred embodiment). This limits a range of reflection angle on the substrate 9 of the reflected light which is drawn into the second aperture plate 452, and the reflected light almost becomes parallel light.

The first polarized light after passing through the slit aperture of the second aperture plate 452 is reflected on the ellipsoidal mirror 453 to be directed to the plane mirror 454, and incident on the spectrometer 43 through an aperture of the third aperture plate 455 fixed on the spectrometer 43. The aperture of the third aperture plate 455 is a square with each side of 100 μm, and positioned at a position which is optically conjugate to the irradiation region on the measurement surface 91 of the substrate 9. In the spectrometer 43, the first polarized light is spectrally split with high wavelength resolution and intensity of light at each wavelength (e.g., each wavelength from ultraviolet ray to near-infrared ray) is measured with high sensitivity.

The spectral intensity of the reflected light acquired by the spectrometer 43 is outputted to the polarization state acquiring part 44 and in the polarization state acquiring part 44, the rotation position of the wave retardation plate 411, the rotation position being outputted from the rotating phase retarder 41, is associated with the output of the spectrometer 43 (i.e., the spectral intensity), to acquire a polarization state at each wavelength of the reflected light, specifically, a phase difference Δ between a p-polarized component and an s-polarized component at each wavelength and an angle Ψ whose tangent gives an amplitude ratio of these reflected polarized components (i.e., a complex amplitude ratio). The polarization state at each wavelength of the reflected light is outputted to the film thickness calculation part 7 from the polarization state acquiring part 44. In the film thickness calculation part 7, ellipsometry is performed on the basis of the polarization state at each wavelength of the reflected light, the polarization state being acquired by the light receiving part 4 in the spectroscopic ellipsometer 1 (i.e., on the basis of the output of the spectrometer 43, which is associated with the rotation position of the wave retardation plate 411 in the rotating phase retarder 41), to obtain a thickness of the film formed on the measurement surface 91 of the substrate 9.

The second polarized light which is led out from the analyzer 42 toward a direction almost perpendicular to the optical axis J2 passes through the ultraviolet light transmitting filter 456 provided on an optical axis J3 between the analyzer 42 and the imaging part 46, and only an ultraviolet component is led out with blocking a visible component. The ultraviolet component of the second polarized light passes the lens 457 to be received by the imaging part 46 and thereby, an image of the irradiation region on the measurement surface 91 of the substrate 9 is picked up to detect the size and the shape of the irradiation region. The acquired image of the irradiation region is outputted to the control part 6 and displayed in a display and the like.

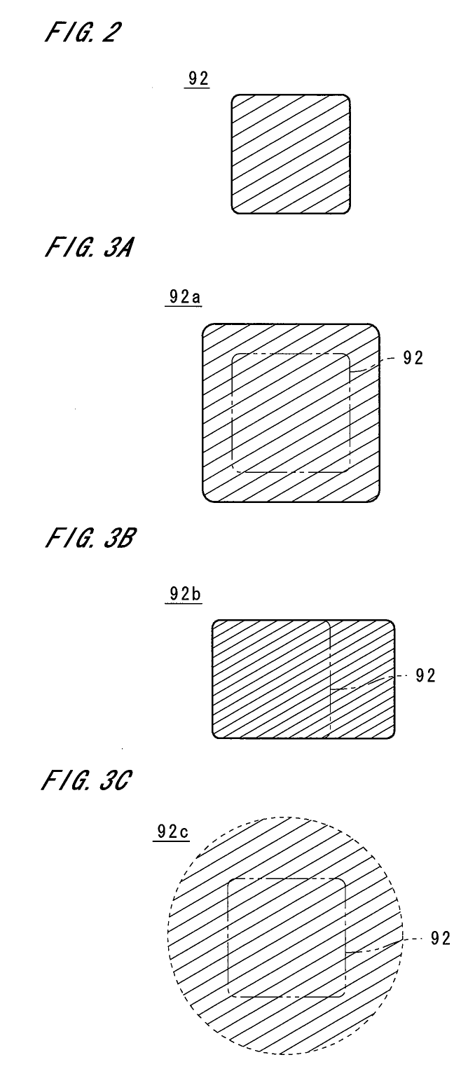

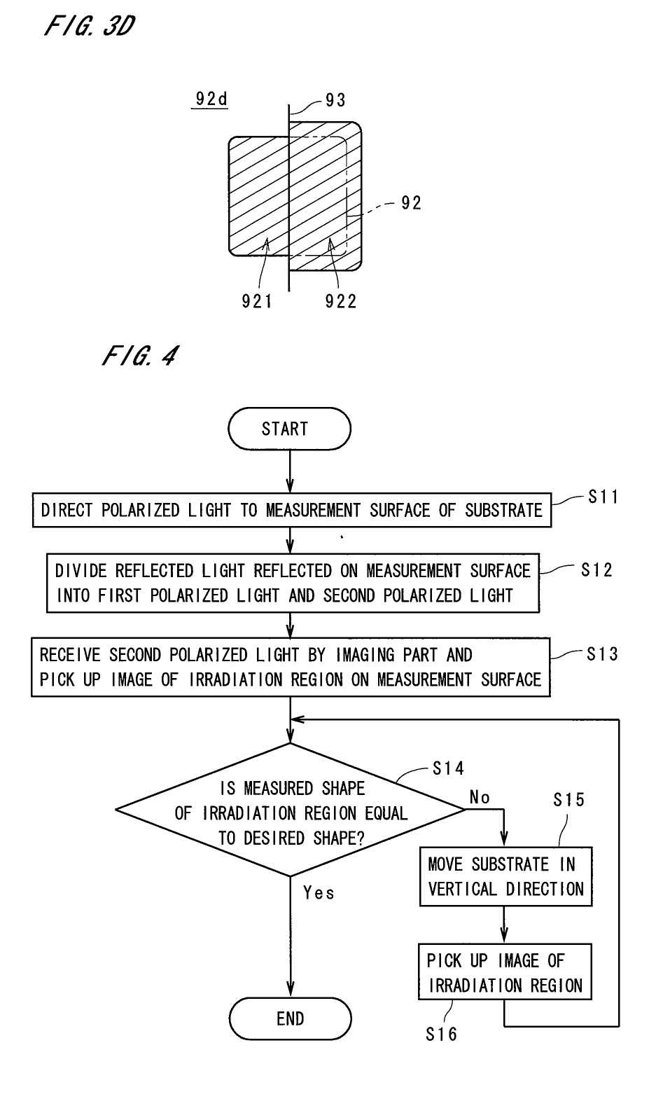

FIG. 2 is a plan view showing the irradiation region 92 on the measurement surface 91 (see FIG. 1) of the substrate 9, an image of the irradiation region 92 being picked up by the imaging part 46. The irradiation region 92 has a desired size and shape (an approximately square with each side of 30 μm as discussed above, and the desired size and shape is hereinafter simply referred to as a “desired shape”). FIGS. 3A to 3D are plan views each showing an example of an irradiation region having a different size and shape from the desired shape, and the irradiation region 92 having the desired shape is shown by a two-dot chain line in each of FIGS. 3A to 3D. The irradiation regions in FIG. 2 and FIGS. 3A to 3D are shown by hatching.

FIG. 3A shows an irradiation region 92a in a case that the measurement surface 91 of the substrate 9 is moved in the vertical direction from a convergence position where the polarized light which is applied to the substrate 9 from the lighting part 3 is most converged (i.e., in a case that the measurement surface 91 is in a defocused state). In this case, the irradiation region 92a becomes an enlarged desired shape (i.e., the irradiation region 92a becomes larger than and similar to the desired shape).

FIG. 3B shows an irradiation region 92b in a case that the polarized light from the lighting part 3 is reflected on both a surface of a transparent film formed on a measurement surface of a substrate and a boundary between the above film and a substrate main body (i.e., in a case that the polarized light from the lighting part 3 is multiply reflected). In this case, the irradiation region 92b spreads in the horizontal direction of FIG. 3B (i.e., the horizontal direction is the Y direction of FIG. 1 and a direction along an ideal surface perpendicular to the measurement surface, the ideal surface including the optical axis J1 on the substrate of the lighting part 3).

FIG. 3C shows an irradiation region 92c in a case that a measurement surface of a substrate is rough (not smooth). In this case, since the polarized light is nonuniformly applied onto the measurement surface, the irradiation region 92c becomes ambiguous and spreads. In FIG. 3C, the ambiguous contour of the irradiation region 92c is shown by a broken-line. FIG. 3C shows an example of the shape of the irradiation region 92c, and the shape of the irradiation region 92c varies depending on a state of projections and depressions on the measurement surface.

FIG. 3D shows an irradiation region 92d in a case that the polarized light from the lighting part 3 is applied to a region of a measurement surface on a substrate, projections and depressions such as a pattern being formed on the measurement surface and the region including an edge 93 of the pattern. In FIG. 3, a left region 921 of the edge 93 on the irradiation region 92d is an irradiation region on a projection on the measurement surface, and a right region 922 of the edge 93 is an irradiation region in a depression on the measurement surface. Since the projection on the measurement surface corresponding to the region 921 is located at the convergence position where the polarized light which is applied to the measurement surface from the lighting part 3 is most converged and the depression on the measurement surface corresponding to the region 922 is located at a position lower than the convergence position, the width and the length of the region 922 in FIG. 3D are larger than those of the region 921.

If film thickness measurement is performed in a case that the irradiation region is a different size or shape from the desired shape as described above (i.e., the shape or size of the irradiation region is unusual), the measurement accuracy is decreased. For this reason, in the film thickness measuring apparatus 10 shown in FIG. 1, an operator checks an image of the irradiation region displayed on the display and the like by visual check and in a case where the size or shape of the irradiation region is unusual, adjusting is performed as necessary so that the irradiation region becomes the desired shape. For example, as shown in FIG. 3A, in the case that the size of the irradiation region is unusual by the defocus of the measurement surface 91 of the substrate 9, the stage elevating mechanism 24 shown in FIG. 1 is driven to move the substrate 9 in the vertical direction together with the stage 2, and the measurement surface 91 of the substrate 9 is moved to the convergence position of the polarized light which is applied to the substrate 9 from the lighting part 3. In the case that the shape of the irradiation region is unusual as shown in FIGS. 3B to 3D, the substrate 9 is moved in the X direction and/or the Y direction of FIG. 1.

As discussed above, in the spectroscopic ellipsometer 1 in the film thickness measuring apparatus 10, the polarization state at each wavelength of the reflected light is measured with use of the first polarized light which is the linearly polarized component in the predetermined polarization direction of the reflected light reflected on the measurement surface 91 of the substrate 9, and the size and shape of the irradiation region on the measurement surface 91 of the substrate 9 are detected with use of the second polarized light which is the linearly polarized component in the polarization direction perpendicular to the first polarized light (i.e., the second polarized light is a remaining polarized light which is acquired by extracting the first polarized light from the reflected light).

In the spectroscopic ellipsometer 1, the imaging part 46 is provided in the light receiving part 4 where measurement of the polarization state of the reflected light reflected on the measurement surface 91 is performed, and the light incident on the light receiving part 4 from the measurement surface 91 is received by the imaging part 46 to detect the size and shape of the irradiation region on the measurement surface 91, and it is therefore possible to detect the size and shape of the irradiation region with high accuracy. Since detection of the size and shape of the irradiation region is performed with use of the second polarized light out of the reflected light reflected on the measurement surface 91, the second polarized light being the polarized component which is not used in measurement of the polarization state, decrease of the light intensity of the first polarized light used in measurement of the polarization state is prevented and decrease of the measurement accuracy of the polarization state is prevented.

That is, in the spectroscopic ellipsometer 1, it is possible to detect the size and shape of the irradiation region on the measurement surface 91 of the substrate 9 with high accuracy with highly maintaining the measurement accuracy of the polarization state of the reflected light. As a result, in the film thickness measuring apparatus 10, film thickness measurement in a state where the size or shape of the irradiation region is unusual is prevented and high precision-film thickness measurement can be achieved on the basis of the reflected light reflected on the irradiation region having the desired shape.

In the light receiving part 4 in the spectroscopic ellipsometer 1, the light which passes through the slit aperture of the second aperture plate 452 to become the almost parallel light enters the spectrometer 43, sin θ₃ being equal to or smaller than 0.05 when 2θ₃ is the viewing angle of the slit aperture, and the polarization state is measured with use of only the almost parallel light (i.e., the light which enters the measurement surface 91 at an almost desired incident angle), and it is therefore possible to improve the measurement accuracy of the polarization state of the reflected light. Since the optical system in the light receiving part 4, from the substrate 9 to the spectrometer 43, is an unmagnification optical system and the aperture of the third aperture plate 455 (i.e., the square with each side of 100 μm) is larger than the irradiation region on the measurement surface 91 (i.e., the square with each side of 30 μm), even if the position of the irradiation region on the measurement surface 91 of the substrate 9 slightly moves from an original position in design, the reflected light reflected on the measurement surface 91 can be surely received by the spectrometer 43 to acquire the polarization state.

In the light receiving part 4, the reflected light after passing through the slit aperture of the first aperture plate 451 is divided into the first polarized light and the second polarized light by the analyzer 42, and sin θ₂ is made 0.1 when 2θ₂ is the viewing angle of the slit aperture, and the second polarized light enters the imaging part 46 without passing through the second aperture plate 452. With this structure, an image of the irradiation region is picked up in the imaging part 46 at high resolution and it is possible to detect the size and shape of the irradiation region with high accuracy. Since the shape of the irradiation region in the case that the size or shape is normal (i.e., the desired shape of the irradiation region) is an approximately rectangle, it is possible to easily detect abnormalities in size and shape of the irradiation region illustrated in FIGS. 3A to 3D.

Since the ultraviolet light transmitting filter 456 provided between the analyzer 42 and the imaging part 46 uses only the ultraviolet component of the second polarized light for performing an image pickup of the irradiation region by the imaging part 46, it is possible to prevent (or suppress) influences on an image pickup of the irradiation region, caused by light other than from the lighting part 3 (the light is so-called disturbance light and little ultraviolet light is normally included in the light) and to improve the detection accuracy of the size and shape of the irradiation region. From the view point of suppressing the influences of the disturbance light, a visible component may be slightly included in the light which is used for an image pickup in the imaging part 46. In this case, a filter which blocks most of visible light and almost transmits only ultraviolet light is used as the ultraviolet light transmitting filter 456.

In the spectroscopic ellipsometer 1 in the above film thickness measuring apparatus 10, detection of abnormality in size or shape of the irradiation region may be performed by the control part 6, instead of detection of abnormality in size or shape of the irradiation region by visual check of the operator. Following discussion will be made on an operation of the spectroscopic ellipsometer 1 in a case where abnormality in size of the irradiation region caused by the defocus of the measurement surface 91 of the substrate 9 shown in FIG. 3A is detected by the control part 6 and adjustment (hereinafter, referred to as “focusing”) where the size of the irradiation region is made to a desired size is performed. FIG. 4 is a flowchart showing a flow of focusing in the spectroscopic ellipsometer 1.

In the spectroscopic ellipsometer 1 shown in FIG. 1, first, the polarized light from the lighting part 3 is directed to the measurement surface 91 so as to be inclined to the measurement surface 91 (Step S11), and the reflected light reflected on the measurement surface 91 is incident on the analyzer 42 through the rotating phase retarder 41 and divided into the first polarized light and the second polarized light (Step S12). Subsequently, the first polarized light and the second polarized light are received by the spectrometer 43 and the imaging part 46, respectively, and an image of the irradiation region on the measurement surface 91 of the substrate 9 is picked up by the imaging part 46 (Step S13).

Next, the size and the shape of the irradiation region on the measurement surface 91 is detected on the basis of output of the imaging part 46 (hereinafter, the above size and shape is referred to as a “measured shape”), and the measured shape is compared with the desired shape of the irradiation region which is stored in the control part 6 in advance (Step S14). In a case where the measured shape of the irradiation region is larger than the desired shape, the stage elevating mechanism 24 is controlled by a focusing part 61 in the control part 6, the substrate 9 is moved in the vertical direction together with the stage 2 and thereafter, the imaging part 46 is controlled to perform an image pickup of the irradiation region (Steps S15, S16).

In the spectroscopic ellipsometer 1, the stage elevating mechanism 24 and the imaging part 46 are controlled by the focusing part 61, comparison of the measured shape and the desired shape of the irradiation region, movement of the substrate 9 in the vertical direction, and image pickup of the irradiation region are thereby repeated, and the substrate 9 is moved toward a direction where an area of the irradiation region becomes smaller (Steps S14 to S16). Movement of the substrate 9 is stopped at a position where the area of the irradiation region becomes minimum (i.e., a position where the measured shape of the irradiation region becomes equal to the desired shape) to complete focusing (Step S14). As discussed above, in the spectroscopic ellipsometer 1, focusing of the substrate 9 is automatically performed by control of the focusing part 61.

Though the preferred embodiment of the present invention has been discussed above, the present invention is not limited to the above-discussed preferred embodiment, but allows various variations.

In the light receiving part 4, a polarization prism (e.g., a Glan-Taylor prism or a Rochon prism) other than the Glan-Thompson prism may be used as the analyzer 42, or a polarization beam splitter for emitting the first polarized light and the second polarized light in parallel with each other with spacing a predetermined distance or the like may be used as the analyzer 42. There may be a case where a sheet-like polarizer which is positioned to be inclined to the optical axis J2 in the light receiving part 4 is used as the analyzer 42 and the reflected light is divided into the first polarized light and the second polarized light.

In the lighting part 3, a heavy hydrogen lamp may be used as the light source 31 for emitting white light including ultraviolet light. Light not including ultraviolet light (e.g., visible light) is applied from the lighting part 3 to a substrate where influences by application of ultraviolet light are concerned. In this case, the ultraviolet light transmitting filter is not provided on the optical axis J3 between the analyzer 42 and the imaging part 46, and a visible light transmitting filter of a specific wavelength band may be provided instead of the ultraviolet light transmitting filter.

In the spectroscopic ellipsometer 1, the rotating phase retarder 41 can be provided between the lighting part 3 and the substrate 9 (i.e., on the optical axis J1 between the polarizer 32 in the lighting part 3 and the substrate 9). Also in this case, it is possible to detect the size and shape of the irradiation region on the measurement surface 91 of the substrate 9 with high accuracy with highly maintaining the measurement accuracy of the polarization state of the reflected light. In the spectroscopic ellipsometer 1, for example, abnormality in shape of the irradiation region caused by multiple reflections shown in FIG. 3B and abnormality in shape of the irradiation region caused by coarse of the surface shown in FIG. 3C are automatically detected by the control part 6 and a warning may be addressed to the operator.

The spectroscopic ellipsometer can be used for apparatuses other than the film thickness measuring apparatus. A surface state and optical constants other than the film thickness of the measurement surface 91 of the substrate 9 may be obtained on the basis of the spectral intensity which is acquired by the spectrometer. Further, ellipsometry of a measurement surface of an object other than the semiconductor substrate may be performed by the spectroscopic ellipsometer.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2007-236277 filed in the Japan Patent Office on Sep. 12, 2007, the entire disclosure of which is incorporated herein by reference.

What is claimed is:

1. A spectroscopic ellipsometer, comprising:
a light irradiation part for directing polarized light to an object, said polarized light being inclined to said object;
an analyzer for dividing light reflected on said object into a first polarized light which is a linearly polarized component in a predetermined polarization direction and a second polarized light which is a linearly polarized component in a polarization direction perpendicular to said first polarized light;
a rotating phase retarder which is positioned between said light irradiation part and said object or between said object and said analyzer and rotates around a central axis parallel to an optical axis;
a spectrometer for receiving said first polarized light; and
an imaging part for receiving said second polarized light to pick up an image of an irradiation region of said polarized light on said object.

2. The spectroscopic ellipsometer according to claim 1, further comprising
an aperture plate which is positioned on an optical axis between said analyzer and said spectrometer and has a slit aperture extending in a direction which is substantially parallel to a measurement surface on said object and perpendicular to said optical axis, and
when 2θ is an angle viewing a width of said slit aperture from an intersection of said measurement surface and said optical axis, sin θ is equal to or smaller than 0.05.

3. The spectroscopic ellipsometer according to claim 2, wherein
light including ultraviolet light is emitted from said light irradiation part, and
an ultraviolet light transmitting filter for transmitting ultraviolet light with blocking visible light is provided on an optical axis between said analyzer and said imaging part.

4. The spectroscopic ellipsometer according to claim 2, wherein
said irradiation region is an approximately rectangle.

5. The spectroscopic ellipsometer according to claim 2, further comprising:
a holding part for holding an object;
an elevating mechanism for moving said object in a vertical direction perpendicular to said measurement surface of said object, together with said holding part; and
a focusing part which controls said elevating mechanism and said imaging part and repeats movement of said object in said vertical direction and image pickup of said irradiation region, to make an area of said irradiation region minimum.

6. The spectroscopic ellipsometer according to claim 1, wherein
light including ultraviolet light is emitted from said light irradiation part, and
an ultraviolet light transmitting filter for transmitting ultraviolet light with blocking visible light is provided on an optical axis between said analyzer and said imaging part.

7. The spectroscopic ellipsometer according to claim 6, wherein
said irradiation region is an approximately rectangle.

8. The spectroscopic ellipsometer according to claim 6, wherein
a holding part for holding an object;
an elevating mechanism for moving said object in a vertical direction perpendicular to said measurement surface of said object, together with said holding part; and
a focusing part which controls said elevating mechanism and said imaging part and repeats movement of said object in said vertical direction and image pickup of said irradiation region, to make an area of said irradiation region minimum.

9. The spectroscopic ellipsometer according to claim 1, wherein
said irradiation region is an approximately rectangle.

10. The spectroscopic ellipsometer according to claim 9, wherein
a holding part for holding an object;
an elevating mechanism for moving said object in a vertical direction perpendicular to said measurement surface of said object, together with said holding part; and
a focusing part which controls said elevating mechanism and said imaging part and repeats movement of said object in said vertical direction and image pickup of said irradiation region, to make an area of said irradiation region minimum.

11. The spectroscopic ellipsometer according to claim 1, wherein
a holding part for holding an object;
an elevating mechanism for moving said object in a vertical direction perpendicular to said measurement surface of said object, together with said holding part; and
a focusing part which controls said elevating mechanism and said imaging part and repeats movement of said object in said vertical direction and image pickup of said irradiation region, to make an area of said irradiation region minimum.

12. A film thickness measuring apparatus for measuring a thickness of a film formed on an object, comprising:
a spectroscopic ellipsometer comprising:
a light irradiation part for directing polarized light to an object, said polarized light being inclined to said object;
an analyzer for dividing light reflected on said object into a first polarized light which is a linearly polarized component in a predetermined polarization direction and a second polarized light which is a linearly polarized component in a polarization direction perpendicular to said first polarized light;
a rotating phase retarder which is positioned between said light irradiation part and said object or between said object and said analyzer and rotates around a central axis parallel to an optical axis;
a spectrometer for receiving said first polarized light;
an imaging part for receiving said second polarized light to pick up an image of an irradiation region of said polarized light on said object; and
a film thickness calculation part for obtaining a thickness of a film formed on said object on the basis of output of said spectrometer, said output being associated with a rotation position of said rotating phase retarder in said spectroscopic ellipsometer.

13. The film thickness measuring apparatus according to claim 12, wherein
said spectroscopic ellipsometer further comprises an aperture plate which is positioned on an optical axis between said analyzer and said spectrometer and has a slit aperture extending in a direction which is substantially parallel to a measurement surface on said object and perpendicular to said optical axis, and
when 2θ is an angle viewing a width of said slit aperture from an intersection of said measurement surface and said optical axis, sin θ is equal to or smaller than 0.05.

14. The film thickness measuring apparatus according to claim 12, wherein
light including ultraviolet light is emitted from said light irradiation part, and
an ultraviolet light transmitting filter for transmitting ultraviolet light with blocking visible light is provided on an optical axis between said analyzer and said imaging part.

15. The film thickness measuring apparatus according to claim 12, wherein
said irradiation region is an approximately rectangle.

16. The film thickness measuring apparatus according to claim 12, wherein
a holding part for holding an object;
an elevating mechanism for moving said object in a vertical direction perpendicular to said measurement surface of said object, together with said holding part; and
a focusing part which controls said elevating mechanism and said imaging part and repeats movement of said object in said vertical direction and image pickup of said irradiation region, to make an area of said irradiation region minimum.
